(19) United States
(12) Patent Application Publication
(10) Pub. No.: US 2010/0186734 A1
(43) Pub. Date: Jul. 29, 2010

(54) SOLAR AIR HEATER FOR HEATING AIR FLOW

(76) Inventor: Paul Riis Arndt, Viby J. (DK)

Correspondence Address: GIFFORD, KRASS, SPRINKLE,ANDERSON & CITKOWSKI, P.C, PO BOX 7021, TROY, MI, 48007-7021, US

(21) Appl. No.: 12/525,377

(22) PCT Filed: Feb. 5, 2008
(86) PCT No.: PCT/DK08/50024

§ 371 Date: Mar. 22, 2010

(30) Foreign Application Priority Data
Feb. 5, 2007 (DK) PA 2007 00195

(51) Int. Cl. F24J 2/04; G05B 15/00; F24J 2/00; F24F 7/00

(52) U.S. Cl. 126/629; 700/278; 126/714; 454/254

(57) ABSTRACT

The invention relates to a solar air heater comprising—at least one transparent or translucent front panel comprising at least one first flow passage, said first flow passage substantially elongated and extending along the surface of the front panel,—a back panel preferably substantially parallel with the front panel,—at least one heat absorbing element, preferably located between the front panel and the back panel,—at least one air inlet,—at least one air outlet,—at least a second flow passage between the front panel and the heat absorption element, and—at least a third flow passage between the heat absorption element and the back panel, whereby air flowing through the solar air heater from an air inlet to an air outlet will pass at least a first, a second and a third flow passage. In a further embodiment of the invention the solar air heater comprises means for driving and/or inverting the airflow through said solar air heater, whereby heating and/or ventilation of a room and/or a building connected to said solar air heater can be provided.

The present invention relates to a solar air heater for heating airflow and a method for same.

### BACKGROUND OF INVENTION

With an increasing focus on global warming and the consequences thereof, renewable energy has attracted increasing interest lately. This combined with the growing demand for insulation of houses, possibly leading to increased humidity, thus providing a need for ventilation and/or improvement of the indoor climate. Also increasing energy prices help to guide consumers toward renewable energy sources, methods for saving energy and reducing energy expenses. Methods and devices for transforming the energy from the sunlight radiating the earth into heat and/or electricity have been known for years. The present application more specifically deals with heating and/or ventilation of buildings by utilizing nothing but sunlight.

EP 1 448 937 B1 describes a solar collector panel for heating an airflow, wherein the solar collector panel comprises solar cells and a ventilator driven by said solar cells. The ventilator drives the airflow through the panel. The inlet of air is provided through a permeable back panel and the outlet of air is provided through a channel in the back panel.

U.S. Pat. No. 7,032,588 B2 describes a solar collector panel for pre-heating ventilation air for a building. Two air collection spaces with an intermediate air flow chamber provide heating of the air, which is driven through the panel by means of a ventilator.

EP 0 380 349 B1 and EP 0 553 893B1 describe solar collecting panels for preheating ventilation air for a building. A plurality of air-inlet openings communicate with air collection channels behind the panels. Outside air passing upwardly along the panel is heated by the heat of the panel which itself is heated by a combination of solar radiation and heat being lost from the interior of the building.

WO 94/12832 A1 describes a solar collector for heating and ventilating homes. The solar collector comprises an absorber and a heat-insulated vessel with a transparent cover. Air is heated first when flowing through the vessel and secondly when subsequently forced to flow on both sides of the absorber.

WO 2006/102891 describes a solar collector panel for utilization of thermal energy obtained from sunlight, e.g. for heating an airflow. The solar collector panel comprises solar cells and a ventilator driven by said solar cells. The ventilator drives the airflow through the panel. Inlet of air is provided through a permeable back panel and possibly through a channel at the bottom of the panel into a flow channel inside the front panel and subsequently into the solar collector panel. Outlet of air is provided through a channel in the back panel.

The main problem with known solar collector panels and with utilizing thermal energy from the sun in general, is the efficiency in regards to transforming the energy from the sunlight into other energy sources, such as heat. An object of the invention is to provide a solar air heater with increased efficiency for heating airflow.

Another problem with known solar collector panels for heating buildings is the one way direction of the airflow, i.e. air is only blown into the buildings. In many situations, such as through a warm summer, the buildings are sufficiently heated or even too warm, especially modern buildings which are heavily insulated. In that case a need for leading air out of the buildings is more urgent, both for ventilation and/or cooling properties. It is a further object of the invention to provide a solar air heater with ventilation and/or cooling properties.

### SUMMARY OF INVENTION

An object of the invention is achieved by a solar air heater comprising
at least one transparent or translucent front panel comprising at least one first flow passage, said first flow passage substantially elongated and extending along the surface of the front panel,
a back panel preferably substantially parallel with the front panel,
at least one heat absorbing element, preferably located between the front panel and the back panel,
at least one air inlet,
at least one air outlet,
at least a second flow passage between the front panel and the heat absorption element, and
at least a third flow passage between the heat absorption element and the back panel, whereby air flowing through the solar air heater from an air inlet to an air outlet will pass at least a first, a second and a third flow passage.

By the current invention efficient heating of airflow can be achieved. The translucent or transparent front panel can be made of glass, a polymer material such as polycarbonate or the like materials. By providing more than one layer of transparent or translucent material in the front panel, better insulation properties will be achieved to avoid a large transfer of heat from the solar air heater through the front panel to the outside. In a preferred embodiment of the invention two layers are provided in the front panel with a distance between the two layers to provide a first flow passage between the layers. When air is provided to the solar air heater through at least one air inlet, the air is subsequently guided through the first flow passage inside the front panel. When the air passes through said first flow passage, it will be heated by a transfer of thermal energy from sunlight streaming through the front panel.

At least one heat absorption element is located between the front panel and the back panel of the solar air heater according to the invention. The heat absorption element is preferably substantially parallel with the front panel and the solar air heater is typically placed at an angle to provide the best possible radiation exposure to sunlight.

Alternately if the solar air heater, due to limitations in the building construction, such as the angle of the roof, has been placed at an angle not optimal for reception of sunlight. In that case the heat absorption element can be placed at an angle in relation to the front panel to provide a better exposure to sunlight streaming through the front panel.

In a preferred embodiment of the invention the heat absorption element comprises a first and a second side. The second flow passage extends along the first side of the heat element and the third flow passage extends along the second side of the heat element. Thereby air flowing through the solar air heater will pass both the first and the second side of the heat absorption element.

The heat absorption element is heated by absorbing part of the sunlight streaming through the front panel. The space between the front panel and the heat absorption element comprises at least one second flow passage. Said second flow passage is in connection with the first flow passage, thus air flowing through the first flow passage will subsequently enter the second flow passage, wherein the air is heated by passing the heat absorption element. The air in the second flow passage will furthermore be subject to heat from sunlight passing through the front panel.

The space between the back panel and the heat absorption element comprises at least one third flow passage. Said third flow passage is in connection with the second flow passage, thus air flowing through the second flow passage will subsequently enter the third flow passage, wherein the air is heated by passing the opposite side of the heat absorption element. Subsequent to passing the third flow passage the air exits the solar air heater through at least one air outlet.

In one embodiment of the invention at least one panel of solar cells is located between the front panel and the heat absorption element, thus providing possible creation of electric energy in the solar air heater by means of the solar cells.

In a further embodiment of the invention ventilation means, such as at least one ventilator or fan, are comprised. The at least one fan is preferably driven by electric energy generated by solar cells. A fan can drive airflow through the solar air heater. Fans are preferably located in or near the air inlet and/or the air outlet.

In a preferred embodiment of the invention the direction of the airflow through the solar air heater can be inverted. Thereby air inlet becomes air outlet and correspondingly air outlet becomes air inlet. If one or more fans are driving the airflow through the solar air heater, the airflow can be inverted by inverting the rotating direction of the fans.

Air provided to the solar air heater is not necessarily clean, e.g. polluted by dust particles. Filtration means, such as a dust filter, can be provided, preferably located in, near and/or adjacent to the air inlet and/or the air outlet. Filtering the air provided to the solar air heater will prolong the lifetime and increase the efficiency of said solar air heater, because dust, filth, dirt and the like will be blocked in a filter before entering the solar air heater. If the solar air heater according to the invention is provided as a heat source of a building or a room, filtering the heated air provided by the solar air heater would be preferable. In a preferred embodiment of the invention the filtration means are replaceable. With time the efficiency of a filter will decrease due the dust deposited in the filter. If replaced the efficiency is restored and clean air is once again provided to and from the solar air heater.

In a preferred embodiment of the invention means for controlling the ventilation are comprised, for example by controlling the speed of a ventilating fan. The airflow through the solar air heater can thereby be controlled. In a further embodiment of the invention, means are comprised for controlling the temperature of the room connected to the output of the solar air heater. The temperature of said room can for example be controlled by varying the output of heated air from the solar air heater, e.g. by varying the speed of a ventilation fan.

With means for controlling, inverting and/or filtering the airflow through the solar air heater, a further object of the invention can be achieved. One embodiment of the solar air heater according to the invention can thereby provide both heating and ventilation of a room, building, car, boat or a caravan. Heating of a room, building, car, boat or a caravan connected to the air outlet is provided by drawing in air from the outside, heating the air by passing through at least three flow passages and blowing in the heated into the connected room, building, car, boat or a caravan. This mode of the solar air heater can be referred to as “the heating mode” or “the winter mode”, because heating is typically needed through a winter period. Ventilation and/or cooling of same room or building can be provided by drawing air out and/or exchanging air from the said room, building, car, boat or a caravan, by means of inverting the airflow in the solar air heater, whereby the air outlet connected to the room or building functions as an air inlet and the air inlet of the solar air heater functions as an air outlet. This mode of the solar air heater according to the invention can be referred to as “the ventilation mode”, “the cooling mode” or “the summer mode”, because through a warm period, typically the summer, cooling and/or ventilation or rooms or building is more urgent than heating. Exchanging between summer and winter mode can be provided automatically by the solar air heater according to the invention. In another embodiment the exchange is provided manually.

It is important that as much as possible of the thermal energy absorbed by the heat absorption element is transferred to the air passing said heat element, i.e. it is important that heat is not dissipated away from the solar air heater. In a preferred embodiment of the invention the back panel comprises insulation, such as at least one layer of insulating material. Thereby the amount of heat transferred through the back panel and to the surroundings is minimized.

On a warm and sunny day the heat absorption element inside the solar air heater according to the invention can obtain a very high temperature leading to a high inside temperature of the solar air heater. This can possibly cause damage to vulnerable parts of the solar air heater. In a preferred embodiment of the invention means for measuring and/or controlling said inside temperature of the solar air heater are comprised.

### DESCRIPTION OF DRAWINGS

The invention will now be described in greater detail with reference to the drawings in which,

FIG. 1 is a cross sectional side view of one embodiment of a solar air heater according to the invention,

FIG. 2 is a cross sectional side view of a second embodiment of a solar air heater according to the invention,

FIG. 3 is a perspective front view of a solar air heater according to the invention,

FIG. 4 is a view of the back of a solar air heater according to the invention,

FIG. 5 is a cross sectional top view of a solar air heater according to the invention,

FIG. 6 is a close up view of the air inlet of another embodiment of a solar air heater according to the invention, and

FIG. 7 is a close up view of the ventilation means of another embodiment of a solar air heater according to the invention.

### DETAILED DESCRIPTION OF THE INVENTION

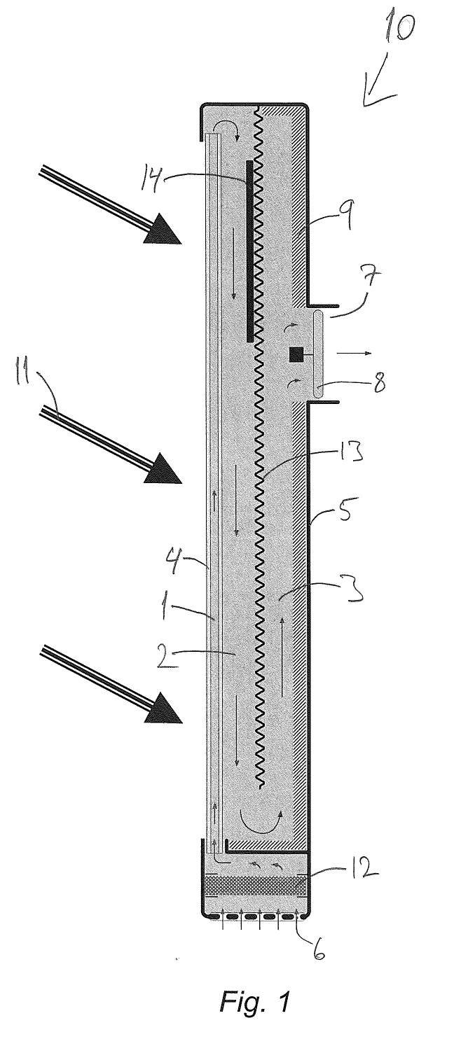

FIG. 1 shows a cross sectional side view of one embodiment of a solar air heater 10 according to the invention, wherein said solar air heater is in heating mode also known as winter mode. The airflow path inside the solar air heater 10 is indicated by arrows. Air enters the solar air heater 10 through an air inlet 6 comprising a plurality of holes in the bottom of the solar air heater 10. The air passes a filter 12 for removing and filtering out dust particles, filth and the like from the incoming air. The air is subsequently guided into a first flow passage 1, inside the translucent or transparent front panel 4. The front panel is preferably made of glass and/or a plastics material such as polycarbonate. The front panel 4 comprises at least two plates where between the first flow passage 1 is located. When the air passes through the first flow passage 1 it will be subject to heat from sunlight 11 passing through the translucent or transparent front panel 4. When the air exits the first flow passage 1 it subsequently enters the second flow passage 2, which is located in the space between the front panel 4 and the heat absorption element 13. The heat absorption element is preferably covered by a dark colour to increase the absorption of thermal energy from the sunlight. The surface of the heat element 13 is preferably wave-like and/or serrated to increase the surface area of the heat element 13 and thereby increase the heat transfer to the air flowing by the heat element 13. When flowing through the second flow passage 2 the air is subject to heat from the sunlight passing through the front panel 4 and from the heat absorption element 13. Subsequent to passing the second flow passage 2 the airflow enters the third flow passage 3 in the space between the other side of the heat element 13 and the back panel 5. In the third flow passage the air is subject to heat from the heat element 13. The airflow exits the solar air heater 10 through an air outlet 7. The back panel is provided with an insulating layer 9 to minimize the heat loss through the back panel 5. In the illustrated embodiment in FIG. 1 the airflow is driven through the solar air heater 10 by means of a ventilation unit 8 located in the air outlet 7. The fan 8 is driven by electric energy generated by means of the solar cell panel 14.

The airflow passage 1 inside the front panel 4 has three functions, all functions helping to increase the thermal efficiency of the solar air heater according to the invention. The flow passage 1 provides an initial heating of the air. It provides better insulation properties of the front panel 4 and thereby better insulation of the entire solar air heater. And the air flowing through the passage 1 helps to avoid the generation of dew, i.e. condensation of, the inside of the flow passage 1. Dew would permit a part of the sunlight from passing the front panel 4 and thereby worsen the thermal efficiency of the solar air heater.

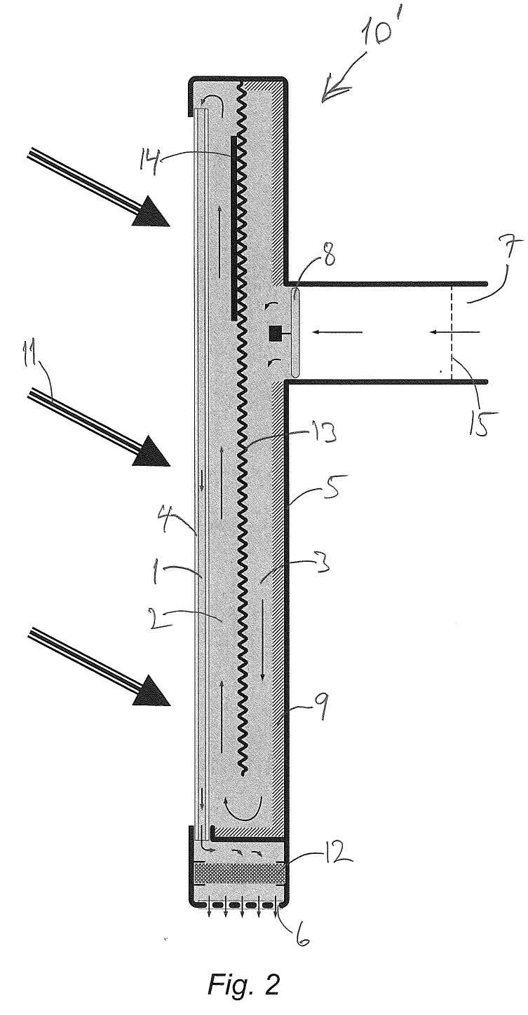

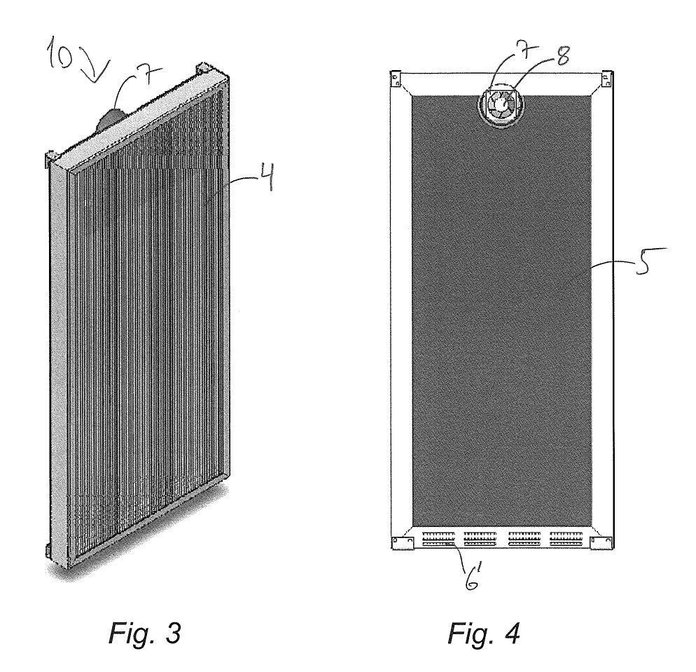

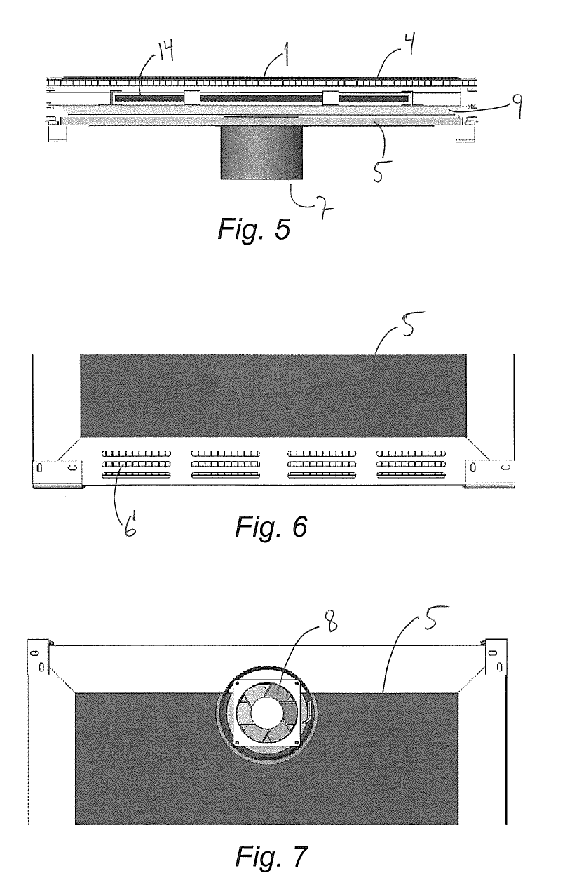

In FIGS. 1 and 2 the inlet of air 6, i.e. an inlet of air 6 when the solar air heater is in heating mode, is provided at the bottom of the solar air heater 10, 10′. In FIG. 4 is shown a second embodiment of a solar air heater wherein the air inlet 6′ is located at the bottom of the back panel. A close-up of the air inlet 6′ is shown in FIG. 6. The ventilation means 8 are located at the top of the back panel 5. The location of the air inlet and air outlet is not particularly important. The air inlet can be provided through the bottom, the side, the front and/or the back of the solar air heater according to the invention. What is important, is that the airflow is guided through at least three flow passages 1, 2, 3 inside the solar air heater, wherein the airflow can be subject to heat in each flow passage 1, 2, 3. The flow passages 1, 2, 3 are preferably running along the length of said solar air heater.

If the air inlet is provided in the front panel, the solar air heater according to the invention can be better integrated in a building construction, such as a roof or a wall, such as a translucent element in a wall. With full integration the sides, the bottom, the top and/or the back panel might not have connection to the surrounding air, but by providing air inlet in e.g. the front panel, the solar air heater will still function as described.

The solar air heater 10′ illustrated in FIG. 2 is very similar to the solar air heater 10 in FIG. 1, except that the direction of the airflow is inverted starting from the air outlet 7 (now an air inlet 7), passing the third flow passage 3, subsequently passing the second flow passage 2, subsequently passing the first flow passage 1 and finally exiting the solar air heater 10′ through the air inlet 6 (now an air outlet 6). The solar air heater 10′ is in ventilation mode, also known as summer mode. The air passage 7 has been provided with filtration means 15 to clean the air before entering the solar air heater 10′. The airflow is inverted just by means of inverting the rotation of the fan 8. The solar air heater 10′ can thereby provide ventilation of a room connected to the air passage 7.

In one embodiment of the invention the solar air heater is part of a ventilation system, i.e. a ventilation system for a building. In such a ventilation system a flow of air is possibly provided, whereby there is no need for ventilation means inside the solar air heater. The air is drawn through the solar air heater according to the invention by an external force, and the solar air heater will only provide heating and/or filtration of the airflow. In a further embodiment of the invention the solar air heaters are arranged in series, i.e. the air outlet from one solar air heater is connected to an air inlet of the next solar air heater in line. Thereby further heating of airflow can be provided.

The means for inverting the airflow through the solar air heater according to the invention have to main functions. Most importantly it provides ventilating properties of the solar air heater. The air of a room connected to solar air heater can be exchanged several times per day by means of using the solar air heater in ventilation mode. In some situations cooling of said room will be provided but ventilation will also provide less humidity in the room and in general better in-door climate. Secondly, inverting the airflow can provide ventilation of the solar air heater itself, thereby avoiding overheating of said panel, whereby damages to vulnerable parts of the solar air heater can be avoided. With a reduced risk of overheating the solar air heater according to the invention, said solar air heater can be placed in direct sunlight and even under conditions with strong and intensive sunlight. At least one temperature sensor can preferably be provided inside the solar air heater, e.g. located inside one of the flow passages 1, 2, 3 and/or at the heat absorption element 13 and/r at the front panel 4 and/or at the back panel 5. Such temperature sensor can provide feedback of the inside temperature of the solar air heater can thereby become self regulating, i.e. when a critical inside temperature is reached, the ventilation through the solar air heater can be increased to lower the inside temperature.

Filtration means inside the solar air heater will preferably provide cleaning of the air blown into a connected room or building. The solar air heater according to the invention can be connected to temperature sensors and/or controllers and/or electrical control circuits for automatic climate control of a room or a building connected to the solar air heater. The temperature of a room can be increased by increasing the airflow through the panel, preferably by means of increasing the power of the ventilation. Decreasing the room or building temperature can be provided by decreasing the airflow through the solar air heater or even by removing air from the room or the building by inverting the airflow through the solar air heater. Humidity sensors can also provide feedback to the solar air heater, for example to initiate exchange of the air in a room. Control of the heating and/or ventilation properties of the solar air heater according to the invention can be provided manually or automatically.

When the solar air heater 10 is only used for heating of air and the airflow is only one-way, i.e. from the air inlet 6 to the air outlet 7, filtration means 12 is only necessary, but not excluded to, in connection with the air inlet 6, for filtering the air entering the solar air heater. When the solar air heater 10′ is used for both heating and ventilation, filtration means 12, 15 can be provided in both the air inlet 6 and the air outlet 7, because in ventilation mode air is sucked in through the outlet 7, whereby filtration 15 can be provided in connection with said outlet 7 to filter air entering the solar air heater 10′ through the outlet 7.

Ventilation means can be provided by a fan 8, but other means for moving airflow can be provided. The advantage of a fan is that the direction of the fan rotation is easily inverted, whereby the direction of the airflow powered by the fan is inverted. Fans can be designed to be almost inaudible to avoid generation of noise in the building of room connected to a solar air heater according to the invention.

Insulation 9 of the back panel 5 is an option. Insulation will provide a heavier and/or bigger solar air heater but will most likely increase the thermal efficiency of the solar air heater according to the invention. At east one layer of insulation around the edges of the internal of the solar air heater can provide for, that the air flowing through said solar air heater does not meet any cold spots and/or cold bridges in the solar air heater, thereby avoiding that the air is cooled of before it flows out of the solar air heater according to the invention. FIGS. 1 and 2 illustrate the insulation of the back panel 5 as a layer 9 of the inside of said back panel 5, but the insulation might just as well be provided on the outside. In a further embodiment of the invention the insulation is applied on the outside of the solar air heater. Thereby a faster and/or easier manufacturing assembly of the solar air heater can be provided. Applying the insulation on the outside followed by sealing of the solar air heater can be somewhat easier than sealing the solar air heater from the inside. Materials such as polystyrene and/or polyurethane can be used as insulation.

The air entering the solar air heater according to the invention preferably passes at least one filter 12, 15 for removing and filtering out dust particles, filth and the like from the incoming air. The filter 12, 15 can preferably be made of felt of a synthetic material. The filter 12, 15 must be dense to catch small particles, but must also be permeable to air to provide a good airflow through the filter 12, 15, thereby helping to provide a good airflow through the solar air heater.

In one embodiment of the invention the solar air heater comprises solar cells 14, such as a panel of solar cells 14. The solar cells 14 preferably comprise silicon. The solar cells 14 must cover a surface large enough to generate enough electric energy, e.g. to power ventilation means. The heat absorption element 13 is preferably made of a light metal with good thermal properties, such as aluminium, and preferably lacquered in a dark colour to increase the absorption of the sunlight 11. The absorption of sunlight and subsequent generation of heat can be increased by providing a wave like surface of the heat absorption element 13. The heat absorption element 13 is preferably corrugated to provide for sufficient rigidity and good absorption of the sunlight 11. The heat absorption element covers as much as possible of the inside area of the solar air heater to catch as much of the sunlight 11 streaming through the front panel 4.

The frame of the solar air heater according to the invention is preferably made of aluminium. A cheaper solution could be fibreglass as the material in the frame and/or the back panel. The inside of the solar air heater is sealed from the outside, i.e. it is preferably impermeable to liquid, such as water.

The solar air heater according to the invention can be applied to buildings for heating and/or ventilation of the entire building of just one or more rooms inside the building. The solar air heater can be installed on the wall and/or a roof construction and/or build into same. The outside design of the solar air heater can be varied, e.g. by using various materials for the front and back panel, to make it fit into various building constructions. In one embodiment of the invention a hardened glass front or glass panel is applied on the outside of the solar air heater, providing the solar air heater with an outside look like glass, such as a window.

The solar air heater according to the invention is not limited to heating and/or ventilation of buildings. Also heating and/or ventilation of cars, trucks, caravans, mobile homes, ships, and/or the like can be provided by the solar air heater according to the invention.

The solar air heater according to the invention is not limited to having three flow passages. A front panel with a triple layer of transparent or translucent material could make room for at least two flow passages inside the front panel. Two or more heat absorption elements, wherein heat absorption elements not directly exposed to sunlight could be heated by for example thermal conductivity, could provide for extra flow passages, e.g. along the extra heat absorption elements. More than three flow passages could provide for increased thermal energy transferred to airflow through the solar air heater and thereby increased efficiency of the solar air heater. As long as the heat absorption elements, or other parts of the solar air heater, are warmer than the airflow passing by, heat will be transferred to the airflow.

The illustrated embodiments of the solar air heater according to the invention are substantially flat, elongated rectangular shaped. The invention is not limited to these shapes. In a further embodiment of the invention any geometrical shape can be imagined, such as circular, elliptical, triangular or the like. Possibly shaped and designed to fit a building construction, but with equal properties as described in this application. The solar air heater can be arranged vertical, horizontal or with an angle to vertical. As long as sunlight and/or daylight hit the front panel it will work.

The solar air heater according to the invention can advantageously be used for holiday homes, e.g. installed on the roof. During the winter period holiday homes are often slightly heated, e.g. to avoid frost in the water pipes and/or the cistern. A solar air heater according to the invention can help warming up and/or ventilating the holiday home, whereby heat expenses can be reduced. Furthermore, a better general indoor climate can be provided by the ventilation properties of the solar air heater, i.e. lower humidity and/or a constant exchange of the inside air can be provided. Thereby the often stuffy and unaired smell inside a holiday home after a period of no use, can be avoided.

In a further embodiment of the invention, heat from the solar air heater can be applied to other target than air. For example by including a system of pipes inside the solar air heater with a flow of liquid, such as water, through the pipes, the heat absorbed by the heat absorption element can be transferred to the pipes and thereby providing a heating of the liquid streaming through the pipes.

1. Solar air heater comprising
at least one transparent or translucent front panel comprising at least one first flow passage, said first flow passage substantially elongated and extending along the surface of the front panel,
a back panel,
at least one heat absorbing element located between the front panel and the back panel,
at least one air inlet,
at least one air outlet,
at least a second flow passage between the front panel and the heat absorption element, and
at least a third flow passage between the heat absorption element and the back panel, whereby air flowing through the solar air heater from an air inlet to an air outlet will pass at least a first, a second and a third flow passage.

2. A solar air heater according to claim 1, wherein
the heat absorption element comprises a first and a second side,
the at least one second flow passage is substantially parallel with and adjacent to the first side of the heat absorbing element, and
the at least one third flow passage is substantially parallel with and adjacent to the second side of the heat absorbing element, whereby air flowing through the solar air heater from an air inlet to an air outlet will pass at least the first and the second side of the heat absorption element.

3. A solar air heater according to claim 1, furthermore comprising at least one panel of solar cells, preferably located between the front panel and the heat absorbing element.

4. A solar air heater according to claim 1, furthermore comprising ventilation means, preferably driven by solar cells and located in, or adjacent to, the air inlet and/or the air outlet.

5. A solar air heater according to claim 1, furthermore comprising means for inverting the flow of air.

6. A solar air heater according to claim 1, furthermore comprising filtration means located in, or adjacent to, the air inlet and/or the air outlet.

7. A solar air heater according to claim 4, furthermore comprising means for controlling the ventilation.

8. A solar air heater according to claim 1, furthermore comprising means for controlling the temperature of a room whereto said solar air heater is connected.

9. A solar air heater according to claim 1, wherein the back panel comprises insulation.

10. A solar air heater according to claim 1, furthermore comprising means for controlling the temperature of the inside of said solar air heater.

11. A method for heating airflow with a solar air heater, said method comprising the steps of
providing an airflow through at least one air inlet in a solar air heater,
providing the airflow through at least a first flow passage in a transparent or translucent front panel of the solar air heater, whereby the airflow is subject to heat from sunlight crossing said front panel,
providing the airflow through at least a second flow passage along at least one heat absorbing element inside the solar air heater, whereby the airflow is subject to heat from a first side of said heat absorbing element,
providing the airflow through at least a third flow passage along the at least one heat absorbing element inside the solar air heater, whereby the airflow is subject to heat from a second side of said heat absorbing element, and
providing the heated airflow through at least one air outlet in the solar air heater.

12. A method for ventilating a room or a building with a solar air heater, said method comprising the steps of
providing an airflow from the room or building through at least one air inlet in a solar air heater,
providing the airflow through at least a third flow passage inside the solar air heater,
providing the airflow through at least a second flow passage inside the solar air heater,
providing the airflow through at least a first flow passage in a transparent or translucent front panel of the solar air heater, and
providing the airflow through at least one air outlet in the solar air heater.

13. A method according to claim 11, whereby the airflow is provided by means of ventilation.

14. A method according to claim 13, whereby the ventilation means are driven by solar cells comprised in the solar air heater.

15. A method according to claim 11, whereby the air provided into the solar air heater and/or the air provided out from the solar air heater is filtered.

16. A method according to claim 13, whereby the ventilation means are controlled.

17. A method according to claim 11, whereby the temperature of a room connected to the solar air heater is controlled by means of regulating the ventilation of said solar air heater.

18. A method according to claim 11, whereby means for inverting the direction of the airflow through the solar air heater is provided.
